(19) United States
(12) Patent Application Publication
(10) Pub. No.: US 2016/0079813 A1
(43) Pub. Date: Mar. 17, 2016

(54) Time Machine Propulsion

(71) Applicant: Roland Arthur Smith, JR., San Luis Obispo, CA (US)

(72) Inventor: Roland Arthur Smith, JR., San Luis Obispo, CA (US)

(21) Appl. No.: 14/044,005

(22) Filed: Oct. 2, 2013

Related U.S. Application Data
(60) Provisional application No. 61/722,980, filed on Nov. 6, 2012.

(51) Int. Cl. H02K 1/17; H02K 3/02

(52) U.S. Cl. CPC H02K 1/17; H02K 3/02

(57) ABSTRACT

The invention relates to a propulsion device for a space craft wherein matter is accelerated to increase its mass and therefor its gravity. A method utilizing Albert Einsteins theory related to the increase in mass with acceleration. Accelerated mass exudes gravity, which can be used to pull objects through space.

### CROSS-REFERENCE TO RELATED APPLICATIONS

The applicant claims the benefit of provisional patent application Ser. No. 61/722,980, filed 2012 Nov. 6 by the present inventor.

### STATEMENT REGARDING FEDERALLY SPONSORED RESEARCH OR DEVELOPMENT

na

### INCORPORATION-BY-REFERENCE OF MATERIAL SUBMITTED ON A COMPACT DISC OR AS A TEXT FILE VIA THE EFS-WEB

na

### STATEMENT REGARDING PRIOR DISCLOSURES BY THE INVENTOR OR A JOINT INVENTOR

Invention is filed under the “first to file” guidelines. The patent states the use of the invention to make gravity: and has not been in production, sale or described in a printed publication in this or a foreign country or in public use or on sale in this country, more than one year prior to the date of application for provisional patent in the United States.

### BACKGROUND OF THE INVENTION

1. Field of the Invention

The invention relates to a space vehicle propulsion device, which makes gravity used to pull space ships thru space time. The device does not have to be connected to a vehicle and might have other uses.

2. Description of Prior Art

The following is a tabulation of some prior art that presently appears relevant:

### U.S. Patents

| Patent Number | Kind Code | Issue Date | Patentee |
|---|---|---|---|
| WO 2005003545 | A1 | Jan. 13, 2005 | Nicholas Paul Robinson |
| U.S. Pat. No. | A | Ap.r 7, 1992 | Alan Bond |
| 5,101,622 | | | |
| P 0591444 | B1 | Sep. 18, 1996 | David R. Criswell |

### BRIEF SUMMARY OF THE INVENTION

In accordance with one embodiment a device that generates gravity by accelerating matter.

### BRIEF DESCRIPTION OF SEVERAL VIEWS OF THE DRAWING(S)

FIG. 1. shows the copper coil in an enclosure with the small piece of mass that responds to ferro-magnetism.

FIG. 2. shows the larger ring stack configuration in an enclosure and includes the internal structures with a partially schematic cross-sectional view where the ring enclosure has been removed.

### DRAWING

### Reference Numerals

| | |
|---|---|
| 10 small piece of mass | 20 electrical power source |
| 30 copper coil | 40 copper coil large ring stack |
| 50 copper coil small ring stack | 60 internal view of large ring stack |

### DETAILED DESCRIPTION OF THE INVENTION

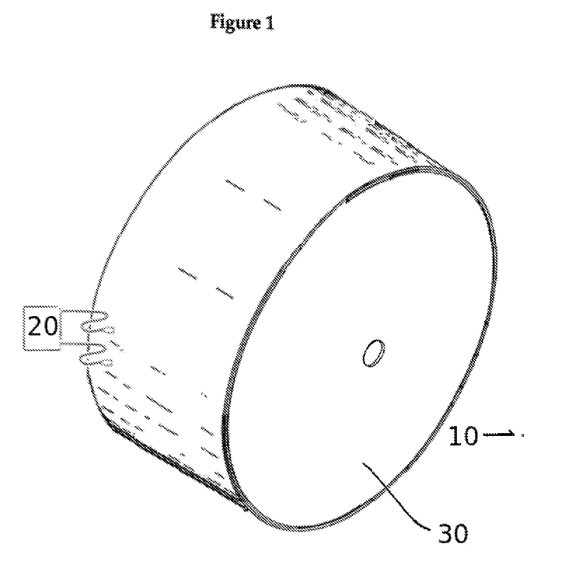

### FIG. 1

One embodiment of the invention is illustrated in FIG. 1. A copper coil 30 is connected to a power supply 20. The copper coil is used to pull a small piece of mass 10, at velocities dependent on the number of turns of copper wire and the power supplied to the copper coil.

Operation—FIG. 1. The manner of using the gravity invention is similar to falling while holding a bunch of stuff. Place the invention at the front of a space vehicle and turn it on. Your ship, yourself, and all the items around you will fall towards the gravity source. It is recommended that only a gravity field equal to the Earths is used during every activation of the invention. Since it is attached, the invention will move as the vehicle moves. To attain extreme velocities simply activate the device repeatedly. This will force the ship to increase in velocity each time the invention is activated. To stop the ship utilize a copy of the invention placed at the rear of the space vehicle and turn it on. In some cases it may be desirable to activate the device repeatedly to reduce the ships velocity to zero.

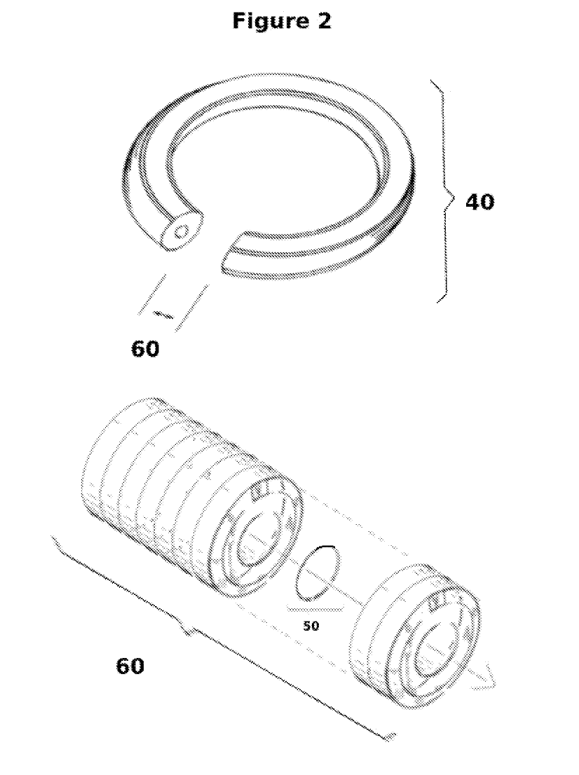

### FIG. 2

### Additional Embodiments

In an alternative embodiment FIG. 2, a plurality of copper coils are made large enough to be arranged into a ring shape 40 designed to move another smaller ring 50 of copper coils within it.

Operation—FIG. 2. The manner of using the ring shape configuration is similar to using the operation in FIG. 1. By activating the copper coils at specific times the collection of copper coils or smaller ring is guided to move through the larger ring at specific velocities. The manner of using the ring shape within another ring shape provides a way of traveling backwards in time. To travel backwards in time activate or move the small piece of mass within the smaller ring generating some gravity. Then, activate the larger ring to move the smaller ring within the larger ring further increasing the mass of the small piece of mass. Turn off the smaller ring and then turn off the larger ring. This generates a negative gravity field or causes the small piece of mass to have less than zero mass. This causes objects to travel backwards in time within that new negative gravity field. The smaller ring is made out of material that responds to the ferro-magnetism of the larger ring.

### CONCLUSION, RAMIFICATIONS, AND SCOPE

It might be only a matter of time before someone invents a time machine. It was Einstein that said velocity is connected to time travel. Apparently you travel forwards in time as you increase in velocity. If Einstein was telling the truth then you will need a way to get back from the future. Especially if you are using gravity for space propulsion. Ironically, the process used to generate gravity can also be manipulated to travel backwards in time. It is obvious that todays propulsion devices do not posses the requirements needed for adequate space travel. And they cannot be used to travel backwards in time. Todays propulsion devices are just not good enough.

The use of a solar sail to generate velocity is not strong enough to move very massive objects. Life support systems and numerous items needed to explore space are massive. Limiting the use of certain important items due to weight restrictions is not acceptable. Even a solar sail made to move large objects is only available near a star.

Rockets have limitations. Only a finite amount of fuel can be carried on a space craft. You might run out of fuel during your trip. There is only a finite amount of rocket fuel on the Earth. We will eventually run out of solid and liquid rocket fuels. Rocket fuel is also expensive.

One proposed device utilizes a nuclear bomb to make a vessel move. The use of large explosions is dangerous. Using a nuclear bomb could kill you simply from the explosion. Humans can sustain damages to their bodies during the acceleration process if to fast. Using a bomb to slow you down can also damage humans. Using a gigantic explosion to turn a ship also can damage humans. And all of these devices can't be used to travel backwards in time.

Nevertheless all the propulsion devices currently used today suffer from a number of disadvantages:

(a) They are not strong enough to move a vessel large enough to hold the items necessary for long space flights or the items needed for colonization.

(b) The costs associated with building and using todays propulsion devices is enormous. The fuel for rockets is extremely expensive. Rocket fuel is a finite resource.

(c) They are not safe.

(d) They are not fast enough to truly explore space.

Accordingly several advantages are as follows: to provide a propulsion device that is strong enough to move large objects and materials, that is safe enough to not kill humans during its operation, and fast enough to move great distances at a price that is affordable.

Accordingly, the reader can instantly begin to see the ramifications and scope of such a device in FIG. 1 being used. It will allow humans to safely transverse great distances at costs that are affordable. It will allow humans to move a massive space vessel.

By attaching the invention in FIG. 1 to the front of a fuselage of an aerospace vehicle the craft will fall towards the gravity source. By attaching the invention to the rear of a fuselage the vessel will slow down or be able to stop. In each case the propulsion device is still available for use since it is attached to the vehicle. Maneuvering through space is possible simply by pulling a vehicle in another direction even while already at a velocity. And the device is strong enough.

A propulsion device has to be strong. By utilizing gravity for space propulsion all the objects in the vessel fall at the same speed. All the items you require move right along with you no matter how heavy they are. The gravitational field moves all mass including the ship. The gravitational field can be quite large moving a large ship full of items no matter how massive it is.

A propulsion device has to be considered safe. Humans can sustain damages to their bodies during both an acceleration process and a deceleration process. Humans can also sustain damages during a high velocity change in direction. Utilizing gravity equal to the Earths for propulsion, deceleration, and when changing direction is considered safe. Due to the large distances associated with space travel adequate velocity is needed.

A propulsion device has to be cheap. Converting mass into energy utilizes finite resources. There is only a finite amount of rocket propellant. The costs of large amounts of explosions over time becomes enormous. The distances associated with space travel can require more money and man power than is available on the Earth. Even the conversion of a planet size amount of rocket fuel to velocity indicates a finite amount of space travel and at slow speeds. And resources used to make rocket fuel are nonrenewable. Once they are gone there is no more space travel.

There are many methods of winding or making ferro-magnetic copper coils. Some methods increase the pulling capacity to enormous amounts. When considering the mass velocities necessary to produce enough gravity to be useful a very effective copper coil construct will be needed. Industry could be generated to make copies of the invention. This creates jobs for people.

Although the device will produce gravity on the planets surface a human being will not feel it. This is because mass favors certain gravitational fields following certain universal rules. You do not feel the suns gravity yet everyone knows that the suns gravity extends well past the Earth and right where you are standing. The moons gravity is also available at your location yet you don't feel it. Scientists should study the concept before its use. In conclusion, the use of gravity for space propulsion is the clear choice when considering an aerospace propulsion device.

It may be possible to use only one atom of iron as the small piece of mass in the invention.

The use of gravity for space propulsion is clearly the best choice for mankind.

1. (canceled)

2. (canceled)

3. (canceled)

4. A device that makes gravity comprising:
a copper coil construct (30) connected to a power source (20) which pulls a piece of mass (10) increasing the mass and gravity of the small piece of mass (10) as it is accelerated.
